(19) United States
(12) Patent Application Publication
(10) Pub. No.: US 2024/0206372 A1
(43) Pub. Date: Jun. 27, 2024

(54) METERING SYSTEM FOR AN AGRICULTURAL PLANTER ROW UNIT

(71) Applicant: CNH Industrial Brasil Ltda., Nova Lima (BR)

(72) Inventors: Regis Carlos Pereira da Silva, Matão (BR); Misael Rissardi, Curitiba (BR); Mario Rodrigues Maia Neto, Piracicaba (BR); Leonardo Reis Menezes, Piracicaba (BR)

(21) Appl. No.: 18/530,830

(22) Filed: Dec. 6, 2023

(30) Foreign Application Priority Data
Dec. 21, 2022 (BR) 10 2022 026242 0

(51) Int. Cl. A01C 7/10; A01C 7/20; A01C 21/00

(52) U.S. Cl. CPC A01C 7/105; A01C 7/205; A01C 21/00

(57) ABSTRACT

A metering system for an agricultural planter row unit includes a controller configured to iteratively perform a first set of operations, including receiving a sensor signal indicative of an agricultural product flow rate through the agricultural planter row unit, comparing the agricultural product flow rate to a target agricultural product flow rate range, returning to receiving the sensor signal indicative of the agricultural product flow rate in response to determining the agricultural product flow rate is within the target agricultural product flow rate range, comparing a fluid pressure differential between opposite sides of a metering device of the metering system to a maximum threshold fluid pressure differential in response to determining the agricultural product flow rate is outside of the target agricultural product flow rate range, and increasing the fluid pressure differential in response to determining the fluid pressure differential is less than the maximum threshold fluid pressure differential.

### BACKGROUND

The present disclosure relates generally to a metering system for an agricultural planter row unit.

Generally, planting implements (e.g., agricultural planters) are towed behind a tractor or other work vehicle. Planting implements typically include multiple row units distributed across a width of the planting implement. Each row unit is configured to deposit agricultural product (e.g., seed, fertilizer, etc.) at a target depth beneath the soil surface of a field, thereby establishing rows of planted agricultural product. For example, each row unit typically includes a ground engaging tool or opener that forms a path (e.g., trench) for agricultural product deposition into the soil. An agricultural product conveying system (e.g., seed tube or powered agricultural product conveyor) is configured to deposit the agricultural product into the trench. The opener/agricultural product conveying system may be followed by closing discs that move displaced soil back into the trench and/or a packer wheel that packs the soil on top of the deposited agricultural product. Furthermore, each row unit may include a metering system configured to control a flow of the agricultural product into the agricultural product conveying system, thereby controlling agricultural product spacing within the soil.

Certain metering systems include a disc having multiple openings. An air pressure differential between opposite sides of the disc induces the agricultural product (e.g., seed, etc.) to be captured within the openings. As the disc rotates, the agricultural product is conveyed toward the agricultural product conveying system. Once the agricultural product (e.g., seed, etc.) enters an outlet that extends to the agricultural product conveying system, the air pressure on each side of the disc is substantially equalized (e.g., at the end of a vacuum passage), thereby enabling the agricultural product (e.g., seed, etc.) to enter the agricultural product conveying system (e.g., seed tube or powered agricultural product conveyor). The agricultural product conveying system then directs the agricultural product to the trench.

In certain planting implements, the air pressure differentials within the metering systems of multiple row units is established by a central pump (e.g., vacuum pump). Fluid lines (e.g., vacuum lines) may extend from the central pump to respective metering systems. In certain planting implements, the row units are distributed along a left wing toolbar and along a right wing toolbar. The left and right wing tool bars are configured to fold forwardly to transition the planting implement from a working configuration to a transport configuration. Accordingly, certain fluid lines extending between the central pump and the respective metering systems may flex as the wing toolbars fold forwardly. Due to repeated flexing of the fluid lines, the fluid lines may be regularly inspected and maintained, thereby increasing maintenance costs for the planting implement. In addition, the central pump may be driven by a hydraulic motor. As such, the planting implement may include hydraulic lines and valve assemblies, thereby increasing the cost and complexity of the planting implement.

### BRIEF DESCRIPTION

In certain embodiments, a metering system for an agricultural planter row unit includes a controller having a memory and a processor. The controller is configured to iteratively perform a first set of operations, which includes receiving a sensor signal indicative of an agricultural product flow rate through the agricultural planter row unit, comparing the agricultural product flow rate to a target agricultural product flow rate range after receiving the sensor signal indicative of the agricultural product flow rate through the agricultural planter row unit, returning to receiving the sensor signal indicative of the agricultural product flow rate in response to determining the agricultural product flow rate is within the target agricultural product flow rate range, comparing a fluid pressure differential between opposite sides of a metering device of the metering system to a maximum threshold fluid pressure differential in response to determining the agricultural product flow rate is outside of the target agricultural product flow rate range, and increasing the fluid pressure differential, via an electrically-driven fluid pump of the metering system, in response to determining the fluid pressure differential is less than the maximum threshold fluid pressure differential. In addition, the controller is configured to iteratively perform a second set of operations, separate from the first set of operations, in response to determining the fluid pressure differential is greater than or equal to the maximum threshold fluid pressure differential, The second set of operations includes comparing the fluid pressure differential to a minimum threshold fluid pressure differential, and decreasing the fluid pressure differential, via the electrically-driven fluid pump of the metering system, in response to determining the fluid pressure differential is greater than the minimum threshold fluid pressure differential.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural planter having multiple row units distributed across a width of the agricultural planter;

FIG. 2 is a side view of an embodiment of a row unit that may be employed on the agricultural planter of FIG. 1;

FIG. 3 is a block diagram of an embodiment of a metering system that may be employed within the row unit of FIG. 2; and

FIG. 4 is a flowchart of an embodiment of a method for operating a metering system of a row unit of an agricultural planter.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

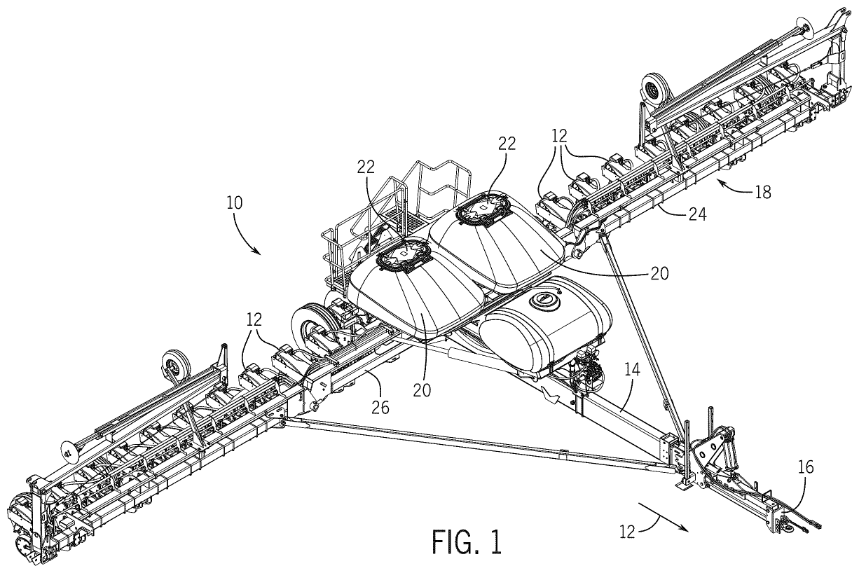

FIG. 1 is a perspective view of an embodiment of an agricultural planter 10 (e.g., planting implement) having multiple row units 12 distributed across a width of the agricultural planter 10. The agricultural planter 10 is configured to be towed through a field behind a work vehicle, such as a tractor. As illustrated, the agricultural planter 10 includes a tongue assembly 14, which includes a hitch 16 configured to couple the agricultural planter 10 to an appropriate tractor hitch (e.g., via a ball, clevis, or other coupling). The tongue assembly 14 is coupled to a tool bar assembly 18 which supports multiple row units 12. Each row unit 12 may include one or more opener discs configured to form a path (e.g., trench) within soil of a field. The row unit 12 may also include an agricultural product conveying system (e.g., agricultural product tube or powered agricultural product conveyer) configured to deposit agricultural product (e.g., seed, fertilizer, etc.) into the path/trench. In addition, the row unit 12 may include closing disc(s) and/or a packer wheel positioned behind the agricultural product conveying system. The closing disc(s) are configured to move displaced soil back into the path/trench, and the packer wheel is configured to pack soil on top of the deposited agricultural product. Furthermore, the row unit 12 may include a metering system configured to control a flow of the agricultural product into the agricultural product conveying system, thereby controlling agricultural product spacing within the soil.

In the illustrated embodiment, the planting implement 10 includes bulk fill product tanks 20 configured to store the agricultural product. Each bulk fill product tank 20 includes a bulk fill tank opening configured to receive the agricultural product, and a cover 22 is configured to selectively cover each respective opening. The planting implement 10 also includes a distribution system configured to convey the agricultural product from the bulk fill product tanks 20 to the row units 12. For example, in certain embodiments, the distribution system may include a pneumatic distribution system having inductor boxes. Each inductor box may be positioned below a respective bulk fill product tank 20, and each inductor box may be configured to receive the agricultural product from the respective bulk fill product tank 20. In addition, each inductor box may receive an air flow, and each inductor box may mix the agricultural product with the air flow to establish a fluidized air/agricultural product mixture. The air/agricultural product mixture may be provided to multiple row units 12 via respective lines that extend from a respective inductor box to the row units 12. While the distribution system includes a pneumatic distribution system in the embodiment disclosed above, in certain embodiments, the distribution system may include another suitable type of distribution system. Furthermore, while the bulk fill product tanks 20 are coupled to the tongue assembly 14/tool bar assembly 18 in the illustrated embodiment, in other embodiments the bulk fill product tanks may be coupled to another suitable implement, which is towed behind or in front of the planting implement. In addition, while the planting implement 10 includes two bulk fill product tanks 20 in the illustrated embodiment, in other embodiments, the planting implement may include more or fewer bulk fill product tanks (e.g., 1, 3, 4, 5, 6 or more). While the planting implement 10 includes bulk fill product tanks 20 in the illustrated embodiment, in other embodiments, the bulk fill product tanks may be omitted, and the agricultural product may be stored within a hopper of each row unit.

In the illustrated embodiment, the toolbar assembly 18 includes a left wing toolbar 24 and a right wing toolbar 26. Each wing toolbar is pivotally coupled to the tongue assembly 14 and configured to rotate relative to the tongue assembly. To transition the agricultural planter 10 from the illustrated working configuration to a transport configuration, actuators may drive the left wing toolbar 24 and the right wing toolbar 26 to fold forwardly (e.g., such that the wing toolbars are parallel to the tongue assembly). As a result, the width of the agricultural planter 10 is reduced, thereby facilitating transport. While the wing toolbars are configured to fold forwardly in the illustrated embodiment, in other embodiments, the wing toolbars may be configured to fold in another suitable manner (e.g., upwardly, rearwardly, etc.), or the position of the wing toolbars may be fixed relative to the tongue assembly. Furthermore, while the agricultural planter 10 has two toolbars in the illustrated embodiment, in other embodiments, the agricultural planter may have more or fewer toolbars (e.g., 1, 3, 4, 5, 6, or more). For example, the agricultural planter may include a single fixed toolbar, or the agricultural planter may include multiple left wing toolbars, multiple right wing toolbars, a center toolbar, or a combination thereof.

In certain embodiments, the metering system of at least one row unit includes a metering device configured to meter the agricultural product through the row unit, and the metering system includes a housing configured to contain the metering device. The metering system also includes an electrically-driven fluid pump fluidly coupled to the housing and configured to establish a fluid pressure differential (e.g., air pressure differential) between opposite sides of the metering device. For example, in certain embodiments, the metering device includes a metering disc having multiple openings. The fluid pressure differential between opposite sides of the metering disc induces the agricultural product (e.g., seed, etc.) to be captured within the openings. As the metering disc rotates, the agricultural product is conveyed toward the agricultural product conveying system. Once the agricultural product enters an outlet that extends to the agricultural product conveying system, the pressure (e.g., air pressure) on each side of the metering disc is substantially equalized, thereby enabling the agricultural product to enter the agricultural product conveying system.

As discussed in detail below, the metering system includes a controller configured to control operation of the metering system. In certain embodiments, the controller is configured to control the fluid pressure differential to enhance the accuracy of the metering system, thereby enhancing the accuracy of agricultural product deposition within the soil. In such embodiments, the controller is configured to iteratively perform a first set of operations, including receiving a sensor signal indicative of an agricultural product flow rate through the row unit. The first set of operations also includes comparing the agricultural product flow rate to a target agricultural product flow rate range after receiving the sensor signal, and returning to receiving the sensor signal in response to determining the agricultural product flow rate is within the target agricultural product flow rate range. Furthermore, the first set of operations includes comparing the fluid pressure differential to a maximum threshold fluid pressure differential in response to determining the agricultural product flow rate is outside of the target agricultural product flow rate range. The first set of operations also includes increasing the fluid pressure differential, via the electrically-driven fluid pump, in response to determining the fluid pressure differential is less than the maximum threshold fluid pressure differential. In addition, the controller is configured to iteratively perform a second set of operations, separate from the first set of operations, in response to determining the fluid pressure differential is greater than or equal to the maximum threshold fluid pressure differential. The second set of operations includes comparing the fluid pressure differential to a minimum threshold fluid pressure differential, and decreasing the fluid pressure differential, via the electrically-driven fluid pump, in response to determining the fluid pressure differential is greater than the minimum threshold fluid pressure differential.

Controlling the fluid pressure differential enhances the accuracy of the metering system by substantially reducing the possibility of capturing more or fewer particles (e.g., seeds, etc.) of the agricultural product at each opening of the metering device (e.g., metering disc, etc.). For example, in certain embodiments, each opening of the metering device may be configured to capture a single seed, thereby enabling the row unit to deposit individual seeds within the soil at a target spacing. In such embodiments, the electrically driven fluid pump may be controlled to substantially reduce the possibility of multiple seeds being captured at an opening (e.g., double) and/or to substantially reduce the possibility of no seeds being captured at an opening (e.g., skip). As a result, the accuracy of agricultural product deposition within the soil may be enhanced.

Furthermore, in certain embodiments, each metering system includes a respective electrically-driven fluid pump. In such embodiments, each electrically-driven fluid pump may be independently controlled to enhance the accuracy of the respective metering system. In addition, electrical lines may extend from one or more central electrical power sources to the electrically-driven fluid pumps, thereby providing electrical power to each electrically-driven fluid pump. For example, the electrical lines may extend from an electrical power system of the work vehicle (e.g., tractor) that tows the agricultural planter 10. Because each metering system includes a respective electrically-driven fluid pump, fluid lines extending from central fluid pump(s) to multiple metering systems are obviated, thereby reducing maintenance costs associated with regular inspection and maintenance of the fluid lines (e.g., due to flexing of the fluid lines in response to transitioning the agricultural planter between the working and transport configurations). In addition, because the fluid pumps are electrically-driven, a complex hydraulic system, including lines and valve assemblies, which may be used to drive hydraulically-driven fluid pumps is obviated, thereby reducing the cost and complexity of the planting implement. While the central electrical power source includes the work vehicle electrical power system in the embodiment disclosed above, in certain embodiments, the central electrical power source(s) may include other suitable electrical power source(s) (e.g., alone or in combination with the work vehicle electrical power system), such as hydraulic motor(s) coupled to generator(s)/alternator(s), pneumatic motor(s) coupled to generator(s)/alternator(s), solar power system(s), energy harvester system(s), other suitable type(s) of electrical power source(s), or a combination thereof.

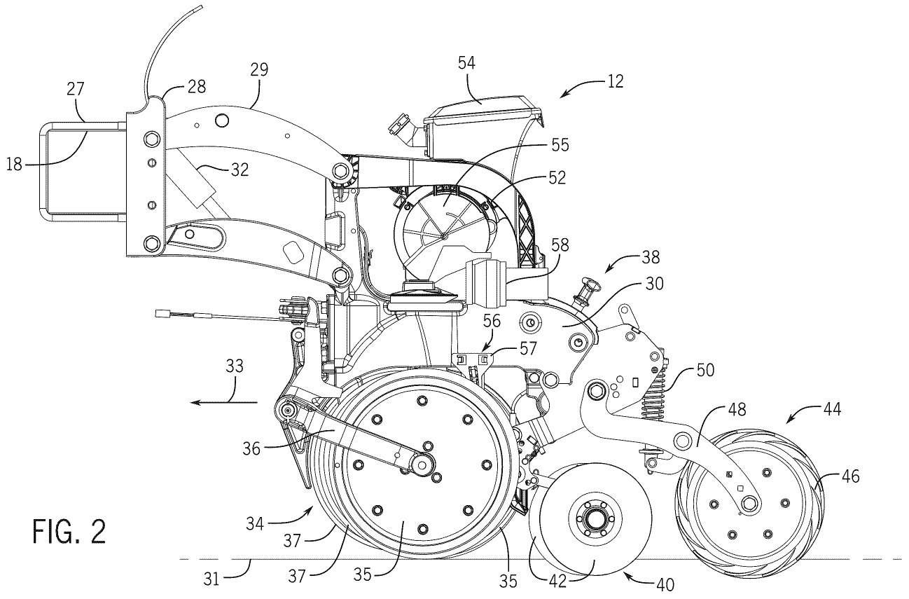

FIG. 2 is a side view of an embodiment of a row unit 12 (e.g., agricultural planter row unit) that may be employed on the agricultural planter of FIG. 1. The row unit 12 includes a mount 27 configured to secure the row unit 12 to the tool bar assembly 18 of the agricultural planter. In the illustrated embodiment, the mount 27 includes a U-bolt that secures a bracket 28 of the row unit 12 to the tool bar assembly 18. However, in other embodiments, the mount may include another suitable device that couples the row unit to the tool bar. A linkage assembly 29 extends from the bracket 28 to a frame 30 of the row unit 12. The linkage assembly 29 is configured to enable vertical movement of the frame 30 relative to the tool bar assembly 18 in response to variations in a soil surface 31. In the illustrated embodiment, an actuator 32 (e.g., hydraulic actuator, pneumatic actuator, electromechanical actuator, etc.) is configured to urge the frame 30 toward the soil surface 31. While the illustrated linkage assembly 29 is a parallel linkage assembly (e.g., a four-bar linkage assembly), in other embodiments, another suitable linkage assembly may extend between the bracket and the frame.

The row unit 12 is configured to deposit agricultural product (e.g., seed, fertilizer, etc.) at a target depth beneath the soil surface 31 as the row unit 12 traverses a field along a direction of travel 33. The row unit 12 includes an opener assembly 34 that forms a trench in the soil for agricultural product deposition into the soil. In the illustrated embodiment, the opener assembly 34 includes gauge wheels 35, arms 36 that pivotally couple the gauge wheels 35 to the frame 30, and opener discs 37. The opener discs 37 are configured to excavate a trench into the soil, and the gauge wheels 35 are configured to control a penetration depth of the opener discs 37 into the soil. In the illustrated embodiment, the row unit 12 includes a depth control system 38 configured to control the vertical position of the gauge wheels 35 (e.g., by blocking rotation of the arms in the upward direction beyond a selected orientation), thereby controlling the penetration depth of the opener discs 37 into the soil.

The row unit 12 also includes an agricultural product conveying system (e.g., seed tube or powered agricultural product conveyor) configured to deposit agricultural product (e.g., seed, fertilizer, etc.) into the trench. The opener assembly 34 and the agricultural product conveying system are followed by a closing assembly 40 that moves displaced soil back into the trench. In the illustrated embodiment, the closing assembly 40 includes two closing discs 42. However, in other embodiments, the closing assembly may include other suitable closing device(s) (e.g., a single closing disc, etc.). In addition, in certain embodiments, the closing assembly may be omitted. In the illustrated embodiment, the closing assembly 40 is followed by a packing assembly 44 configured to pack soil on top of the deposited agricultural product. The packing assembly 44 includes a packer wheel 46, an arm 48 that pivotally couples the packer wheel 46 to the frame 30, and a biasing member 50 configured to urge the packer wheel 46 toward the soil surface 31, thereby enabling the packer wheel to pack soil on top of the deposited agricultural product. While the illustrated biasing member 50 includes a spring, in other embodiments, the biasing member may include another suitable biasing device, such as a hydraulic cylinder or a pneumatic cylinder, among others. Furthermore, in certain embodiments, the packing assembly may be omitted.

The row unit 12 includes a vacuum agricultural product meter 52 (e.g., metering system) configured to receive agricultural product (e.g., seed, fertilizer, etc.) from a hopper 54. The hopper 54, in turn, may receive the agricultural product from a respective bulk fill product tank via the distribution system (e.g., pneumatic distribution system). In certain embodiments, the vacuum agricultural product meter 52 includes a metering disc (e.g., metering device) having multiple openings. The vacuum agricultural product meter 52 also includes a housing 55 that contains the metering disc. An air pressure differential between opposite sides of the metering disc induces the agricultural product (e.g., seed, etc.) to be captured within the openings. As the metering disc rotates, the agricultural product is conveyed toward the agricultural product conveying system. Once the agricultural product (e.g., seed, etc.) enters an outlet that extends to the agricultural product conveying system, the air pressure on each side of the metering disc is substantially equalized (e.g., at the end of a vacuum passage), thereby enabling the agricultural product (e.g., seed, etc.) to enter the agricultural product conveying system (e.g., seed tube or powered agricultural product conveyor). The agricultural product conveying system then directs the agricultural product to the trench. While the row unit 12 includes a vacuum agricultural product meter in the illustrated embodiment, in other embodiments, other suitable types of metering systems may be utilized. For example, in certain embodiments, the metering system may be a positive pressure product meter, in which the pressure differential is provided by a positive pressure air source, as compared to a vacuum air source of the vacuum agricultural product meter disclosed above. As used herein, “vacuum” refers to an air pressure that is less than the ambient atmospheric air pressure, and not necessarily 0 pa. Furthermore, while a metering disc is disclosed above, in certain embodiments, the metering system may include another suitable metering device (e.g., metering drum, etc.) having multiple openings for the agricultural product.

In the illustrated embodiment, the row unit 12 includes a scraper assembly 56 having an outer scraper 57 coupled to the frame 30 and configured to engage an outer surface of an opener disc 37. Furthermore, in certain embodiments, the scraper assembly may include an inner scraper configured to engage an inner surface of the opener disc 37. The scraper assembly 56 is configured to remove accumulated soil from the opener disc 37, thereby enhancing the accuracy and efficiency of the seed path/trench forming process. Furthermore, in certain embodiments, the scraper assembly may include a second outer scraper and, in certain embodiments, a second inner scraper configured to remove accumulated soil from a second opener disc of the row unit.

In the illustrated embodiment, the vacuum agricultural product meter 52 includes an electrically-driven fluid pump 58 fluidly coupled to the housing 55 and configured to establish the pressure differential between opposite sides of the metering disc. The electrically-driven fluid pump 58 includes an electric motor configured to drive a fluid propulsion device (e.g., fan, blade(s), impeller, blower, piston, etc.) to move (e.g., rotate or translate), thereby adjusting fluid pressure (e.g., air pressure) within the housing 55. For example, in certain embodiments (e.g., in embodiments in which the metering system is a vacuum agricultural product meter), the electrically-driven fluid pump may reduce the pressure on one side of the metering device (e.g., metering disc), and the other side of the metering device may be substantially at atmospheric pressure. Furthermore, in certain embodiments, (e.g., in embodiments in which the metering system is a positive pressure product meter), the electrically-driven fluid pump may increase the pressure on one side of the metering device (e.g., metering disc), and the other side of the metering device may be substantially at atmospheric pressure. In certain embodiments, each metering device (e.g., vacuum agricultural product meter 52) of the agricultural planter includes a respective electrically-driven fluid pump 58, thereby facilitating independent control of the pressure differential for each metering device. Furthermore, while the fluid is air in the embodiments disclosed herein, in certain embodiments, the fluid may include other or additional fluid(s), such as water, nitrogen, etc.

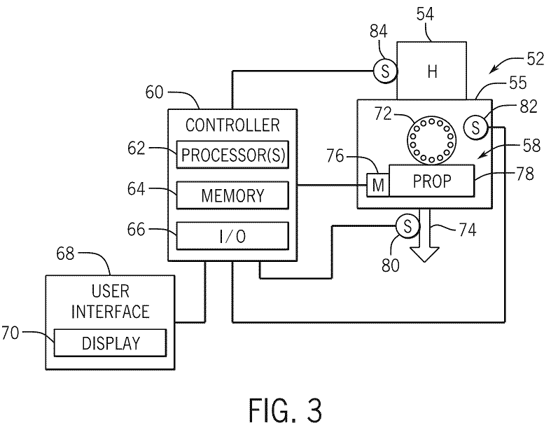

FIG. 3 is a block diagram of an embodiment of the vacuum agricultural product meter 52 (e.g., metering system) that may be employed within the row unit of FIG. 2. In the illustrated embodiment, the vacuum agricultural product meter 52 includes a controller 60 having one or more processors 62 and a memory 64. The processor(s) 62 may be configured to process instructions for execution within the controller 60. The processor(s) 62 may include single-threaded processor(s), multi-threaded processor(s), or both. The processor(s) 62 may be configured to process instructions stored in the memory 64 or on storage device(s). For example, the processor(s) 62 may execute instructions for the various methods described herein. The processor(s) 62 may include hardware-based processor(s), each including one or more cores. The processor(s) 62 may include general purpose processor(s), special purpose processor(s), or both.

The memory 64 may store information within the controller 60. In some implementations, the memory 64 includes one or more computer-readable media. The memory 64 may include any number of volatile memory units, any number of non-volatile memory units, or both volatile and non-volatile memory units. The memory 64 may include read-only memory, random access memory, or both. In some examples, the memory 64 may be employed as active or physical memory by one or more executing software modules.

The memory 64 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the controller 60. In some implementations, the CRSM may include a data store that provides storage of computer-readable instructions or other information in a non-transitory format. The CRSM may be incorporated into the controller 60 or may be external with respect to the controller 60. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices. In some examples, the processor(s) 62 and the memory 64 may be supplemented by, or incorporated into, one or more application-specific integrated circuits (ASICs).

The controller 60 may include one or more I/O devices 66. The I/O devices 66 may include one or more I/O interfaces to enable components or modules of the controller 60 to control, interface with, or otherwise communicate with other devices (e.g., sensor(s), motor(s), etc.). The I/O interface(s) may enable information to be transferred in or out of the controller 60 through serial communication, parallel communication, or other types of communication. The I/O interface(s) may also include one or more network interfaces that enable communication between the controller 60 and other network-connected computing systems. The network interface(s) may include one or more network interface controllers (NICs) or other types of transceiver devices configured to send and receive communications over one or more communication networks using any suitable network protocol.

In the illustrated embodiment, a user interface 68 is communicatively coupled to the controller 60. In the illustrated embodiment, the user interface 68 includes a display 70 configured to present information to an operator. In certain embodiments, the display 70 may include a touch-screen interface configured to receive input from the operator. The user interface may be physically integrated with the controller, or the user interface may be separate from the controller.

As previously discussed, the vacuum agricultural product meter 52 (e.g., metering system) is configured to receive agricultural product (e.g., seed, fertilizer, etc.) from the hopper 54. In the illustrated embodiment, the vacuum agricultural product meter 52 includes a metering disc 72 (e.g., metering device) having multiple openings. An air pressure differential between opposite sides of the metering disc 72 induces the agricultural product (e.g., seed, etc.) to be captured within the openings. As the metering disc rotates, the agricultural product is conveyed toward the agricultural product conveying system 74. Once the agricultural product (e.g., seed, etc.) enters an outlet that extends to the agricultural product conveying system, the air pressure on each side of the metering disc is substantially equalized (e.g., at the end of a vacuum passage), thereby enabling the agricultural product (e.g., seed, etc.) to enter the agricultural product conveying system 74 (e.g., seed tube or powered agricultural product conveyor). The agricultural product conveying system 74 then directs the agricultural product to the trench.

Furthermore, as previously discussed, the vacuum agricultural product meter 52 includes the electrically-driven fluid pump 58, which is fluidly coupled to the housing 55 and configured to establish the pressure differential between opposite sides of the metering disc 72. The electrically-driven fluid pump 58 includes an electric motor 76 configured to drive a fluid propulsion device 78 (e.g., fan, blade(s), impeller, blower, piston, etc.) to move (e.g., rotate or translate), thereby adjusting fluid pressure (e.g., air pressure) within the housing 55. For example, the electrically-driven fluid pump 58 may reduce the pressure on one side of the metering disc 72, and the other side of the metering disc 72 may be substantially at atmospheric pressure. In the illustrated embodiment, the electric motor 76 is communicatively coupled to the controller 60, thereby enabling the controller 60 to control operation of the electrically-driven fluid pump 58.

In the illustrated embodiment, the vacuum agricultural product meter 52 includes a flow sensor 80, a pressure sensor 82, and a product level sensor 84. As illustrated, the flow sensor 80, the pressure sensor 82, and the product level sensor 84 are communicatively coupled to the controller 60, and each sensor is configured to output a respective sensor signal to the controller 60. The flow sensor 80 is configured to output a respective sensor signal (e.g., first sensor signal) indicative of an agricultural product flow rate through the row unit. In the illustrated embodiment, the flow sensor 80 is positioned along the agricultural product conveying system 74 (e.g., seed tube or powered agricultural product conveyor) and configured to detect passage of individual particles (e.g., seeds, etc.) through the agricultural product conveying system 74. The flow sensor 80 may include any suitable type of sensor configured to monitor flow of the agricultural product through the row unit (e.g., the agricultural product conveying system of the row unit). For example, the flow sensor 80 may include infrared sensor(s), optical sensor(s) (e.g., camera(s)), capacitance sensor(s), ultrasonic sensor(s), other suitable type(s) of sensor(s), or a combination thereof. While the vacuum agricultural product meter 52 includes a single flow sensor 80 in the illustrated embodiment, in other embodiments, the vacuum agricultural product meter may include multiple flow sensors (e.g., 2, 3, 4, or more). Furthermore, while the flow sensor 80 is positioned along the agricultural product conveying system 74 and configured to detect passage of individual particles in the illustrated embodiment, in other embodiments, the flow sensor may be positioned at another suitable location on the row unit, and/or the flow sensor may be configured to monitor the mass/volumetric flow rate of the agricultural product.

In the illustrated embodiment, the pressure sensor 82 is fluidly coupled to the housing 55, and the pressure sensor 82 is configured to output a respective sensor signal (e.g., third sensor signal) indicative of the fluid pressure differential (e.g., air pressure differential) between opposite sides of the metering disc 72. For example, the pressure sensor may be in fluid communication with the lower-pressure side of the metering disc 72, and the pressure sensor 82 may be configured to monitor the fluid pressure at the lower-pressure side of the metering disc 72 relative to atmospheric pressure (e.g., the pressure at the higher-pressure side of the metering disc). Furthermore, in certain embodiments, the pressure sensor may be in fluid communication with both sides of the metering disc, and the pressure sensor may be configured to monitor the fluid pressure differential based on the pressure difference between the two sides. Furthermore, in certain embodiments, the vacuum agricultural product meter may include a second pressure sensor configured to monitor the fluid pressure at the higher-pressure side of the metering disc. In such embodiments, the controller may determine the pressure differential based on feedback from both pressure sensors (e.g., by subtracting the monitored pressures). The pressure sensor configurations disclosed above may be applied to positive pressure product meters and product meters having other suitable metering devices (e.g., metering drums, etc.).

In addition, in the illustrated embodiment, the product level sensor 84 is coupled to the hopper 54 and configured to output a respective sensor signal (e.g., second sensor signal) indicative of an agricultural product level within the hopper 54. The product level sensor 84 may include any suitable type(s) of sensor(s) configured to monitor the level of the agricultural product within the hopper 54. For example, the product level sensor 84 may include camera(s), infrared sensor(s), contact sensor(s), potentiometer(s), capacitive sensor(s), LIDAR sensor(s), RADAR sensor(s), other suitable type(s) of sensor(s), or a combination thereof.

In certain embodiments, the controller 60 is configured to determine the agricultural product flow rate based on feedback from the flow sensor 80, the controller is configured to determine the fluid pressure differential based on feedback from the pressure sensor 82, and the controller is configured to determine the agricultural product level based on feedback from the product level sensor 84. While the vacuum agricultural product meter 52 includes the flow sensor 80, the pressure sensor 82, and the product level sensor 84 in the illustrated embodiment, in other embodiments, at least one of the sensors may be omitted. For example, in certain embodiments, the product level sensor may be omitted. Additionally or alternatively, in certain embodiments, the pressure sensor may be omitted, and the pressure differential may be determined by the controller. For example, the controller may control the electrically-driven fluid pump to establish a fluid pressure differential, and the fluid pressure differential established by the controller may be used within the method disclosed below. Furthermore, in certain embodiments, each vacuum agricultural product meter 52 has a respective controller 60. However, in other embodiments, multiple vacuum agricultural product meters may share a common controller. For example, the agricultural planter may have a single controller that is shared by each vacuum agricultural product meter.

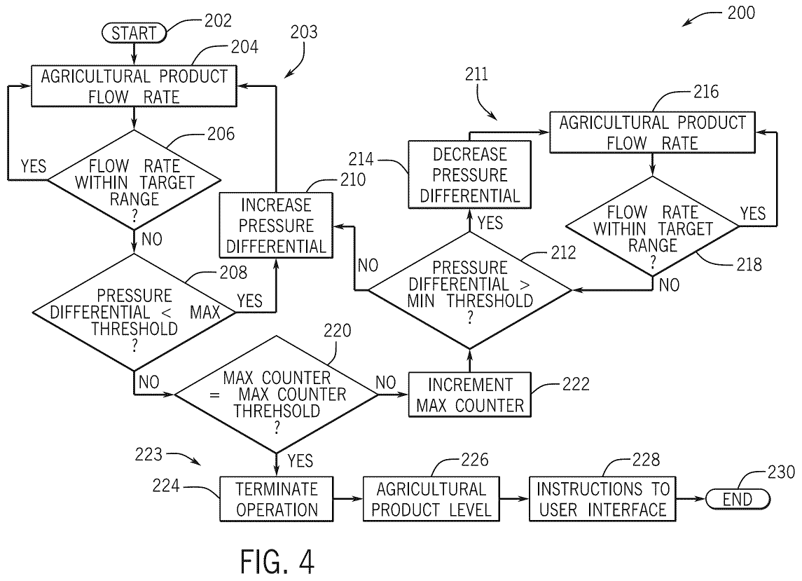

FIG. 4 is a flowchart of an embodiment of a method 200 for operating a metering system of a row unit of an agricultural planter. The method 200 may be implemented as computer code or instructions stored in the memory and executed via the processor of the controller disclosed above with reference to FIG. 3. In the illustrated embodiment, the method 200 starts at block 202. Once the method starts, a first set of operations 203 is iteratively performed (e.g., by the controller disclosed above). The first set of operations 203 includes receiving a sensor signal indicative of an agricultural product flow rate through the row unit of the agricultural planter, as represented by block 204. As previously discussed, in certain embodiments, the sensor signal may be output by a flow sensor positioned along the agricultural product conveying system and configured to detect passage of individual particles.

Furthermore, the first set of operations 203 includes comparing the agricultural product flow rate to a target agricultural product flow rate range, as represented by block 206, after receiving the sensor signal indicative of the agricultural product flow rate through the row unit of the agricultural planter. In certain embodiments, the target agricultural product flow rate range may be input by an operator (e.g., via the user interface) and/or automatically determined (e.g., by the controller). For example, the operator may input a target agricultural product flow rate, and the target agricultural product flow rate range may be automatically determined (e.g., by the controller) based on the input target agricultural product flow rate, or the target agricultural product flow rate range may be automatically determined (e.g., by the controller) without operator input. In certain embodiments, the target agricultural product flow rate range may be determined, at least in part, by artificial intelligence. For example, data of various target agricultural product flow rates for field types (e.g., fields with certain types of soil, irrigation systems, drainage, sun exposure, wind exposure, ambient temperature profiles, rain profiles, etc.), types of agricultural product, field production metrics (e.g., yield, etc.), or a combination thereof, may be used (e.g., by the controller) to train a machine learning process (e.g., stored within the controller) to determine the target agricultural product flow rate range.

In response to determining the agricultural product flow rate is within the target agricultural product flow rate range, the method returns to receiving the sensor signal indicative of the agricultural product flow rate. As illustrated, the operations of comparing the agricultural product flow rate to the target agricultural product flow rate range and receiving the sensor signal indicative of the agricultural product flow rate are iteratively repeated until the agricultural product flow rate is outside of the target agricultural product flow rate range. As used herein, “within the target agricultural product flow rate range” is inclusive of the maximum and minimum values of the range. In response to determining the agricultural product flow rate is outside of the target agricultural product flow rate range, a fluid pressure differential between opposite sides of the metering device (e.g., metering disc, etc.) is compared to a maximum threshold fluid pressure differential, as represented by block 208. As illustrated, the operation of comparing the fluid pressure differential to the maximum threshold fluid pressure differential is part of the first set of operations 203. As previously discussed, in certain embodiments, the fluid pressure differential may be determined (e.g., via the controller) based on feedback from a pressure sensor fluidly coupled to the housing of the metering system and configured to output a sensor signal indicative of the fluid pressure differential between opposite sides of the metering device (e.g., metering disc). In certain embodiments, the maximum threshold fluid pressure differential may be input by an operator (e.g., via the user interface). In other embodiments, the maximum threshold fluid pressure differential may be determined (e.g., by the controller) via artificial intelligence, such as via machine learning. For example, data may be collected of various fluid pressure differentials and the corresponding difference between agricultural product flow rate and target agricultural product flow rate for each fluid pressure differential. The data may be used (e.g., by the controller) to train a machine learning process (e.g., stored within the controller) to determine the maximum threshold fluid pressure differential.

The first set of operations 203 also includes increasing the fluid pressure differential via the electrically-driven fluid pump, as represented by block 210. In response to determining the fluid pressure differential is less than the maximum threshold fluid pressure differential, the fluid pressure differential is increased, and the method returns to receiving the sensor signal indicative of the agricultural product flow rate. In certain embodiments, the controller controls the electric motor of the electrically-driven fluid pump to adjust (e.g., decrease) the pressure on one side of the metering device (e.g., metering disc) to increase the fluid pressure differential. An agricultural product flow rate outside of the target agricultural product flow rate range and a fluid pressure differential less than the maximum threshold fluid pressure differential may indicate that one or more particles are released from the metering device (e.g., metering disk) before the particle(s) reach the outlet that extends to the agricultural product conveying system and/or that no particle is captured at one or more openings of the metering device (e.g., metering disc), which may be known as skip(s). Accordingly, increasing the fluid pressure differential may reduce the possibility of early particle release/skip(s), thereby adjusting the agricultural product flow rate to be within the target agricultural product flow rate range. In certain embodiments, the fluid pressure differential may be increased in a fixed increment. For example, the fixed increment may be input by an operator (e.g., via the user interface), or the fixed increment may be automatically determined (e.g., by the controller, such as by using artificial intelligence/machine learning). Furthermore, in certain embodiments, the fluid pressure differential may be increased by a variable increment. For example, the variable increment may be determined (e.g., by the controller) based on the difference between the fluid pressure differential and the maximum threshold fluid pressure differential, the difference between the agricultural product flow rate and the target agricultural product flow rate range (e.g., a maximum or a minimum of the target agricultural product flow rate range), other suitable parameter(s), or a combination thereof. As illustrated, the first set of operations 203 iteratively repeats until the fluid pressure differential is greater than or equal to the maximum threshold fluid pressure differential.

In response to determining the fluid pressure differential is greater than or equal to the maximum threshold fluid pressure differential, a second set of operations 211 is iteratively performed (e.g., by the controller disclosed above). As illustrated, the second set of operations 211 is separate from the first set of operations 203. The second set of operations 211 includes comparing the fluid pressure differential to a minimum threshold fluid pressure differential, as represented by block 212. As previously discussed, in certain embodiments, the fluid pressure differential may be determined (e.g., via the controller) based on feedback from a pressure sensor fluidly coupled to the housing of the metering system and configured to output a sensor signal indicative of the fluid pressure differential between opposite sides of the metering device (e.g., metering disc). In certain embodiments, the minimum threshold fluid pressure differential may be input by an operator (e.g., via the user interface). In other embodiments, the minimum threshold fluid pressure differential may be determined (e.g., by the controller) via artificial intelligence, such as via machine learning. For example, data may be collected of various fluid pressure differentials and the corresponding difference between agricultural product flow rate and target agricultural product flow rate for each fluid pressure differential. The data may be used (e.g., by the controller) to train a machine learning process (e.g., stored within the controller) to determine the minimum threshold fluid pressure differential. In certain embodiments, the maximum threshold fluid pressure differential is greater than the minimum threshold fluid pressure differential. For example, the maximum threshold fluid pressure differential may be 6 MPa, and the minimum threshold fluid pressure differential may be 4 MPa.

The second set of operations 211 also includes decreasing the fluid pressure differential via the electrically-driven fluid pump, as represented by block 214. In response to determining the fluid pressure differential is greater than the minimum threshold fluid pressure differential, the fluid pressure differential is decreased. In certain embodiments, the controller controls the electric motor of the electrically-driven fluid pump to adjust (e.g., increase) the pressure on one side of the metering device (e.g., metering disc) to decrease the fluid pressure differential. An agricultural product flow rate outside of the target agricultural product flow rate range and a fluid pressure differential greater than or equal to the maximum threshold fluid pressure differential may indicate that multiple particles are captured by at least one opening, which may be known as double(s). Accordingly, decreasing the fluid pressure differential may reduce the possibility of double(s), thereby adjusting the agricultural product flow rate to be within the target agricultural product flow rate range. In certain embodiments, the fluid pressure differential may be decreased in a fixed increment. For example, the fixed increment may be input by an operator (e.g., via the user interface), or the fixed increment may be automatically determined (e.g., by the controller, such as by using artificial intelligence/machine learning). Furthermore, in certain embodiments, the fluid pressure differential may be decreased by a variable increment. For example, the variable increment may be determined (e.g., by the controller) based on the difference between the fluid pressure differential and the maximum threshold fluid pressure differential, the difference between the fluid pressure differential and the minimum threshold fluid pressure differential, the difference between the agricultural product flow rate and the target agricultural product flow rate range (e.g., a maximum or a minimum of the target agricultural product flow rate range), other suitable parameter(s), or a combination thereof. The increment for decreasing the fluid pressure differential may be equal to the increment for increasing the fluid pressure differential, or the increment for decreasing the fluid pressure differential may be different than the increment for increasing the fluid pressure differential.

In certain embodiments, the second set of operations 211 includes receiving the sensor signal indicative of the agricultural product flow rate through the row unit of the agricultural planter, as represented by block 216, after decreasing the fluid pressure differential. As previously discussed, in certain embodiments, the sensor signal may be output by the flow sensor positioned along the agricultural product conveying system and configured to detect passage of individual particles. Furthermore, in certain embodiments, the second set of operations 211 includes comparing the agricultural product flow rate to the target agricultural product flow rate range, as represented by block 218, after receiving the sensor signal indicative of the agricultural product flow rate of the second set of operations. In response to determining the agricultural product flow rate is within the target agricultural product flow rate range, the method returns to receiving the sensor signal indicative of the agricultural product flow rate of the second set of operations 211. As illustrated, the operations of comparing the agricultural product flow rate to the target agricultural product flow rate range and receiving the sensor signal indicative of the agricultural product flow rate are iteratively repeated until the agricultural product flow rate is outside of the target agricultural product flow rate range. Furthermore, in response to determining the agricultural product flow rate is outside of the target agricultural product flow rate range, the method returns to comparing the fluid pressure differential to the minimum threshold fluid pressure differential.

As illustrated, the second set of operations 211 iteratively repeats until the fluid pressure differential is less than or equal to the minimum threshold fluid pressure differential. In certain embodiments, the second set of operations 211 includes returning to increasing the fluid pressure differential of the first set of operations 203 in response to determining the fluid pressure differential is less than or equal to the minimum threshold fluid pressure differential. Accordingly, with regard to the first set of operations 203, if the agricultural product flow rate is outside of the target agricultural product flow rate range, the fluid pressure differential is progressively increased until the agricultural product flow rate is within the target agricultural product flow rate range, which may indicate that increasing the fluid pressure differential substantially reduced early particle release/skip(s), or the fluid pressure differential becomes greater than or equal to the maximum threshold fluid pressure differential, which may indicate that the agricultural product flow rate being outside of the target agricultural product flow rate range is not caused by early particle release/skip(s). In addition, with regard to the second set of operations 211, the fluid pressure differential is progressively decreased until the agricultural product flow rate is within the target agricultural product flow rate range, which may indicate that decreasing the fluid pressure differential substantially reduced double(s), or the fluid pressure differential becomes less than or equal to the minimum threshold fluid pressure differential, which may indicate that the agricultural product flow rate being outside of the target agricultural product flow rate range is not caused by double(s). As indicated above, if the fluid pressure differential becomes less than or equal to the minimum threshold fluid pressure differential, the method returns to the first set of operations 203, and the fluid pressure differential is progressively increased.

In certain embodiments, performing the first set of operations 203 and performing the second set of operations 211 may be terminated in response to the agricultural product flow rate remaining outside of the target agricultural product flow rate range after the fluid pressure differential is repeatedly increased and decreased. In the illustrated embodiment, in response to determining the fluid pressure differential is greater than or equal to the maximum threshold fluid pressure differential, a maximum pressure differential counter value is compared to a maximum pressure differential counter threshold, as represented by block 220. The maximum pressure differential counter threshold may be set to 1, 2, 3, 4, or any other suitable value. In certain embodiments, the maximum pressure differential counter threshold may be input by an operator (e.g., via the user interface) or automatically determined (e.g., by the controller). For example, the controller may automatically determine the maximum pressure differential counter threshold using artificial intelligence/machine learning. In response to determining the maximum pressure differential counter value is less than the maximum pressure differential counter threshold, the maximum pressure differential counter value is increased by one, as represented by block 222. The method 200 then returns to comparing the fluid pressure differential to the minimum threshold fluid pressure differential of the second set of operations 211 after increasing the maximum pressure differential counter value.

In response to determining the maximum pressure differential counter value is equal to the maximum pressure differential counter threshold, a third set of operations 223 is performed (e.g., by the controller disclosed above). The maximum pressure differential counter value being equal to the maximum pressure differential counter threshold may indicate that repeatedly performing the first set of operations 203 and the second set of operations 211 may not result in the agricultural product flow rate entering the target agricultural product flow rate range. As a result, the first and second sets of operations are terminated, and the third set of operations 223 is performed. In the illustrated embodiment, the third set of operations 223 includes terminating operation of the metering system, as represented by block 224. Operation of the metering system may be terminated by terminating operation of the electrically-driven fluid pump and terminating operation of the drive (e.g., electric motor) for the metering device (e.g., metering disc).

Furthermore, in the illustrated embodiment, the third set of operations 223 includes receiving a sensor signal (e.g., second sensor signal) indicative of an agricultural product level within the hopper of the row unit of the agricultural planter, as represented by block 226. As previously discussed, the sensor signal may be received from the product level sensor coupled to the hopper and configured to output the sensor signal indicative of the agricultural product level within the hopper. In certain embodiments, the controller is configured to determine the agricultural product level within the hopper based on feedback from the product level sensor, and the controller may inform the operator of the agricultural product level (e.g., via the user interface). If the agricultural product level is below a threshold, the operator or the controller may determine that the agricultural product flow rate is outside of the target agricultural product flow rate range because the hopper is empty or nearly empty.

In addition, in the illustrated embodiment, the third set of operations 223 includes outputting a signal to the user interface indicative of instructions to correct the agricultural product flow rate, as represented by block 228. The user interface, in turn, may present an indication to the operator (e.g. via the display) indicative of instructions to correct the agricultural product flow rate. The operator may then perform a diagnostic process, which may include determining the flow rate of the agricultural product from the bulk fill product tank to the hopper, determining the operational status of the metering device drive, identifying a clogged agricultural product conveying system, identifying a disruption in electrical power to the electric motor of the electrically-driven fluid pump, other suitable task(s), or a combination thereof. In certain embodiments, the controller may control the user interface to guide the operator through the diagnostic process. The method 200 may then end, as represented by block 230.

While the third set of operations 223 includes terminating operation of the metering system, receiving the second sensor signal indicative of the agricultural product level within the hopper of the row unit, and outputting the signal to the user interface indicative of instructions to correct the agricultural product flow rate in the illustrated embodiment, in other embodiments, at least one of the operations may be omitted (e.g., all of the operations may be omitted). Furthermore, in certain embodiments, the third set of operations may include at least one other operation, such as automatically determining the flow rate of the agricultural product from the bulk fill product tank to the hopper, automatically determining the operational status of the metering device drive, automatically identifying a clogged agricultural product conveying system, automatically identifying a disruption in electrical power to the electric motor of the electrically-driven fluid pump, other suitable operation(s), or a combination thereof. Any such determination(s)/identification(s) may be reported to the operator (e.g., via the user interface). In addition, at least one parameter determined by artificial intelligence/machine learning (e.g., including the target agricultural product flow rate range, the maximum threshold fluid pressure differential, the minimum threshold fluid pressure differential, and the increments) may be determined during operation of the row unit, and/or at least one parameter determined by machine learning may be determined prior to operation of the row unit (e.g., during an initialization process before field operations, before planting operations for a season, at the time of manufacture of the agricultural planter, etc.).

Furthermore, in certain embodiments, the method 200 disclosed above may be utilized for multiple metering systems of the agricultural planter. In such embodiments, the method may be performed (e.g., by a respective controller, by a shared controller, etc.) for each metering system independently, thereby enabling independent fluid pressure differential control for the metering systems of the agricultural planter. In addition, in certain embodiments, the agricultural planter may include wing sensors configured to output respective signals indicative of the positions of the respective wing toolbars. The controller(s) may be configured to determine the positions of the wing toolbars based on feedback from the wing sensors, and the controller(s) may disable/terminate operation of the metering systems (e.g., by disabling/terminating operation of the metering device drives and the electrically-driven fluid pumps) in response to determining the agricultural planter is not in the working configuration, in which the wing toolbars are completely unfolded. Furthermore, in certain embodiments, the electrically-driven fluid pump may remain in operation while rotation of the metering device (e.g., metering disc) is terminated (e.g., during a headland turn, etc.), thereby maintaining engagement of the particles (e.g., seeds) with the openings of the metering device while the metering device is not rotating. As a result, the accuracy of the agricultural product deposition process may be enhanced.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A metering system for an agricultural planter row unit, comprising:
a controller comprising a memory and a processor, wherein the controller is configured to:
iteratively perform a first set of operations, comprising:
receiving a sensor signal indicative of an agricultural product flow rate through the agricultural planter row unit;
comparing the agricultural product flow rate to a target agricultural product flow rate range after receiving the sensor signal indicative of the agricultural product flow rate through the agricultural planter row unit;
returning to receiving the sensor signal indicative of the agricultural product flow rate in response to determining the agricultural product flow rate is within the target agricultural product flow rate range;
comparing a fluid pressure differential between opposite sides of a metering device of the metering system to a maximum threshold fluid pressure differential in response to determining the agricultural product flow rate is outside of the target agricultural product flow rate range; and
increasing the fluid pressure differential, via an electrically-driven fluid pump of the metering system, in response to determining the fluid pressure differential is less than the maximum threshold fluid pressure differential; and
iteratively perform a second set of operations, separate from the first set of operations, in response to determining the fluid pressure differential is greater than or equal to the maximum threshold fluid pressure differential, wherein the second set of operations comprises:
comparing the fluid pressure differential to a minimum threshold fluid pressure differential; and
decreasing the fluid pressure differential, via the electrically-driven fluid pump of the metering system, in response to determining the fluid pressure differential is greater than the minimum threshold fluid pressure differential.

2. The metering system of claim 1, wherein the second set of operations comprises receiving the sensor signal indicative of the agricultural product flow rate through the agricultural planter row unit after decreasing the fluid pressure differential.

3. The metering system of claim 2, wherein the second set of operations comprises:
comparing the agricultural product flow rate to the target agricultural product flow rate range after receiving the sensor signal indicative of the agricultural product flow rate of the second set of operations;
returning to receiving the sensor signal indicative of the agricultural product flow rate of the second set of operations in response to determining the agricultural product flow rate is within the target agricultural product flow rate range; and
returning to comparing the fluid pressure differential to the minimum threshold fluid pressure differential in response to determining the agricultural product flow rate is outside of the target agricultural product flow rate range.

4. The metering system of claim 1, wherein the second set of operations comprises returning to increasing the fluid pressure differential of the first set of operations in response to determining the fluid pressure differential is less than or equal to the minimum threshold fluid pressure differential.

5. The metering system of claim 1, wherein the controller is configured to:
compare a maximum pressure differential counter value to a maximum pressure differential counter threshold in response to determining the fluid pressure differential is greater than or equal to the maximum threshold fluid pressure differential;
increase the maximum pressure differential counter value by one in response to determining the maximum pressure differential counter value is less than the maximum pressure differential counter threshold; and
return to comparing the fluid pressure differential to the minimum threshold fluid pressure differential of the second set of operations after increasing the maximum pressure differential counter value.

6. The metering system of claim 5, wherein the controller, in response to determining the maximum pressure differential counter value is equal to the maximum pressure differential counter threshold, is configured to perform a third set of operations, comprising:
terminating operation of the metering system;
receiving a second sensor signal indicative of an agricultural product level within a hopper of the agricultural planter row unit;
outputting a signal to a user interface indicative of instructions to correct the agricultural product flow rate; or
a combination thereof.

7. The metering system of claim 1, wherein the controller is configured to determine the maximum threshold fluid pressure differential, the minimum threshold fluid pressure differential, or a combination thereof, via machine learning.

8. A metering system for an agricultural planter row unit, comprising:
a metering device configured to meter agricultural product through the agricultural planter row unit;
a housing containing the metering device;
an electrically-driven fluid pump fluidly coupled to the housing and configured to establish a fluid pressure differential between opposite sides of the metering device;
a flow sensor configured to output a sensor signal indicative of an agricultural product flow rate through the agricultural planter row unit; and
a controller communicatively coupled to the electrically-driven fluid pump and to the flow sensor, wherein the controller comprises a memory and a processor, and the controller is configured to:
iteratively perform a first set of operations, comprising:
receiving the sensor signal from the flow sensor;
comparing the agricultural product flow rate to a target agricultural product flow rate range after receiving the sensor signal;
returning to receiving the sensor signal in response to determining the agricultural product flow rate is within the target agricultural product flow rate range;
comparing the fluid pressure differential to a maximum threshold fluid pressure differential in response to determining the agricultural product flow rate is outside of the target agricultural product flow rate range; and
increasing the fluid pressure differential, via the electrically-driven fluid pump, in response to determining the fluid pressure differential is less than the maximum threshold fluid pressure differential; and
iteratively perform a second set of operations, separate from the first set of operations, in response to determining the fluid pressure differential is greater than or equal to the maximum threshold fluid pressure differential, wherein the second set of operations comprises:
comparing the fluid pressure differential to a minimum threshold fluid pressure differential; and
decreasing the fluid pressure differential, via the electrically-driven fluid pump, in response to determining the fluid pressure differential is greater than the minimum threshold fluid pressure differential.

9. The metering system of claim 8, wherein the second set of operations comprises receiving the sensor signal from the flow sensor after decreasing the fluid pressure differential.

10. The metering system of claim 9, wherein the second set of operations comprises:
comparing the agricultural product flow rate to the target agricultural product flow rate range after receiving the sensor signal of the second set of operations;
returning to receiving the sensor signal of the second set of operations in response to determining the agricultural product flow rate is within the target agricultural product flow rate range; and
returning to comparing the fluid pressure differential to the minimum threshold fluid pressure differential in response to determining the agricultural product flow rate is outside of the target agricultural product flow rate range.

11. The metering system of claim 8, wherein the second set of operations comprises returning to increasing the fluid pressure differential of the first set of operations in response to determining the fluid pressure differential is less than or equal to the minimum threshold fluid pressure differential.

12. The metering system of claim 8, wherein the controller is configured to:
compare a maximum pressure differential counter value to a maximum pressure differential counter threshold in response to determining the fluid pressure differential is greater than or equal to the maximum threshold fluid pressure differential;
increase the maximum pressure differential counter value by one in response to determining the maximum pressure differential counter value is less than the maximum pressure differential counter threshold; and
return to comparing the fluid pressure differential to the minimum threshold fluid pressure differential of the second set of operations after increasing the maximum pressure differential counter value.

13. The metering system of claim 12, wherein the controller, in response to determining the maximum pressure differential counter value is equal to the maximum pressure differential counter threshold, is configured to perform a third set of operations, comprising:
terminating operation of the metering system;
receiving a second sensor signal indicative of an agricultural product level within a hopper of the agricultural planter row unit;
outputting a signal to a user interface indicative of instructions to correct the agricultural product flow rate; or
a combination thereof.

14. The metering system of claim 8, wherein the controller is configured to determine the maximum threshold fluid pressure differential, the minimum threshold fluid pressure differential, or a combination thereof, via machine learning.

15. The metering system of claim 8, comprising a pressure sensor fluidly coupled to the housing and communicatively coupled to the controller, wherein the pressure sensor is configured to output a third sensor signal indicative of the fluid pressure differential.

16. A method for operating a metering system of an agricultural planter row unit, comprising:
iteratively performing a first set of operations via a controller comprising a memory and a processor, comprising:
receiving a sensor signal indicative of an agricultural product flow rate through the agricultural planter row unit;
comparing the agricultural product flow rate to a target agricultural product flow rate range after receiving the sensor signal indicative of the agricultural product flow rate through the agricultural planter row unit;
returning to receiving the sensor signal indicative of the agricultural product flow rate in response to determining the agricultural product flow rate is within the target agricultural product flow rate range;
comparing a fluid pressure differential between opposite sides of a metering device of the metering system to a maximum threshold fluid pressure differential in response to determining the agricultural product flow rate is outside of the target agricultural product flow rate range; and
increasing the fluid pressure differential, via an electrically-driven fluid pump of the metering system, in response to determining the fluid pressure differential is less than the maximum threshold fluid pressure differential; and
iteratively performing a second set of operations, separate from the first set of operations, via the controller, in response to determining the fluid pressure differential is greater than or equal to the maximum threshold fluid pressure differential, wherein the second set of operations comprises:
comparing the fluid pressure differential to a minimum threshold fluid pressure differential; and
decreasing the fluid pressure differential, via the electrically-driven fluid pump of the metering system, in response to determining the fluid pressure differential is greater than the minimum threshold fluid pressure differential.

17. The method of claim 16, wherein the second set of operations comprises:
receiving the sensor signal indicative of the agricultural product flow rate through the agricultural planter row unit after decreasing the fluid pressure differential;
comparing the agricultural product flow rate to the target agricultural product flow rate range after receiving the sensor signal indicative of the agricultural product flow rate of the second set of operations;
returning to receiving the sensor signal indicative of the agricultural product flow rate of the second set of operations in response to determining the agricultural product flow rate is within the target agricultural product flow rate range; and
returning to comparing the fluid pressure differential to the minimum threshold fluid pressure differential in response to determining the agricultural product flow rate is outside of the target agricultural product flow rate range.

18. The method of claim 16, wherein the second set of operations comprises returning to increasing the fluid pressure differential of the first set of operations in response to determining the fluid pressure differential is less than or equal to the minimum threshold fluid pressure differential.

19. The method of claim 16, comprising:
comparing, via the controller, a maximum pressure differential counter value to a maximum pressure differential counter threshold in response to determining the fluid pressure differential is greater than or equal to the maximum threshold fluid pressure differential;
increasing, via the controller, the maximum pressure differential counter value by one in response to determining the maximum pressure differential counter value is less than the maximum pressure differential counter threshold; and
returning, via the controller, to comparing the fluid pressure differential to the minimum threshold fluid pressure differential of the second set of operations after increasing the maximum pressure differential counter value.

20. The method of claim 19, comprising, in response to determining the maximum pressure differential counter value is equal to the maximum pressure differential counter threshold, performing a third set of operations, via the controller, comprising:
terminating operation of the metering system;
receiving a second sensor signal indicative of an agricultural product level within a hopper of the agricultural planter row unit;
outputting a signal to a user interface indicative of instructions to correct the agricultural product flow rate; or
a combination thereof.
